(19) United States
(12) Patent Application Publication
(10) Pub. No.: US 2007/0021186 A1
(43) Pub. Date: Jan. 25, 2007

(54) Multi-level simple Keno

(76) Inventor: Garry Allen Hamud, Las Habra, CA (US)

Correspondence Address: William C. Fuess, Suite 2G, 10951 Sorrento Valley Road, San Diego, CA, 92121-1613, US

(21) Appl. No.: 11/510,866

(22) Filed: Aug. 24, 2006

Related U.S. Application Data
(63) Continuation-in-part of application No. 10/268,826, filed on Oct. 10, 2002, now Pat. No. 6,814,228.

(51) Int. Cl. G06F 19/00

(52) U.S. Cl. 463/18

(57) ABSTRACT

In a keno game the keno draw is made from numbers within a multiplicity of fields, or boards, of numbers, with (1) each field, or board, having all the numbers normal to the keno game, and with (2) at least one field, or board, having associated with at least one number of the field, or board, a secondary indicia, or differentiator, each being of one or more types each of which types is called a “color”. No two numbers of the keno draw are the same whether plain or colored, but the keno draw of different numbers can contain one or more numbers each of one or more colors. Keno wagers, or tickets, containing winning numbers matching the keno draw sufficient for a winning payout are paid full normal amounts if the matched numbers are all plain numbers, but if the winning numbers of the keno ticket contain some predetermined quantity of numbers that match numbers of the keno draw that are colored numbers, then the winning payout is increased above levels that would correspondingly have been paid should the same winning payout of the keno ticket matched only numbers of the keno draw that were plain numbers.

### REFERENCE TO A RELATED PATENT APPLICATION

The present application is related as a continuation-in-part to U.S. utility patent application Ser. No. 10/268,826 filed Nov. 11, 2005, for ELECTRONIC VIDEO POKER USING MULTIPLE DECKS OF CARDS HAVING BOTH CONVENTIONAL PRIMARY AND ADDITIONAL, SECONDARY, IDENTITIES IN ORDER TO RESPECTIVELY MAKE BOTH CONVENTIONAL NORMAL, AND SPECIAL JACKPOT, PAY-OUTS. Said application Ser. No. 10/268,826 is itself a continuation-in-part of U.S. utility patent application Ser. No. 11/194,712 filed Aug. 2, 2005, and Ser. No. 11/196,825 filed Aug. 4, 2005, for Worldwide Electronic Video Poker, now abandoned.

The present application is also related to U.S. utility patent application Ser. No. ______ for INCREMENTAL INCREASING LEVELS OF PLAY, NADA (LOSING HAND) PAYOUT, AND STAND ALONE AND/OR LINKED PROGRESSIVE-JACKPOT ELECTRONIC VIDEO POKER GAMES, and Ser. No. ______ for MULTI-LEVEL SIMPLE LOTTO, both filed on an even date with the present application.

All predecessor and related applications are to the selfsame Gary Allen Hamud who is the inventor of the present application. The contents of all predecessor and related applications are incorporated herein by reference.

### BACKGROUND OF THE INVENTION

1. Field of the Invention

The present and related predecessor inventions and applications have to do with, and relate to, the general field of casino gaming, and more particularly to casino Keno as is played both at a table, live action, and on an electronic computer system, usually in the form of an electronic gaming station or electronic video machine.

The predecessor U.S. patent application Ser. No. 10/268,826 filed Nov. 11, 2005, for ELECTRONIC VIDEO POKER USING MULTIPLE DECKS OF CARDS HAVING BOTH CONVENTIONAL PRIMARY AND ADDITIONAL, SECONDARY, IDENTITIES IN ORDER TO RESPECTIVELY MAKE BOTH CONVENTIONAL NORMAL, AND SPECIAL JACKPOT, PAY-OUTS particularly concerns a gambling method, and a computer system, for playing casino electronic poker where the poker cards have both (1) conventional primary identities upon which primary identities normal and conventional payouts are based in a conventional manner, and where these same poker cards also have (2) secondary identities, non-conflicting with and ancillary to the primary identities, upon which secondary identities new and unconventional “jackpot” payouts are based.

The present invention and application particularly concern new variations, using the same methods, applied to the play of casino Keno. These variations are realizable in accordance with the predecessor and related inventions. These variations are perceived (1) to offer unique features that are both exciting and attractive to players of table and electronic Keno, and (2) to be profitable for a gaming establishment in that the new games generally induce and permit increases to such degree as may be desired, in each and any of the Keno table or Keno machine average wager, wagering rate, gross earnings, and/or earnings rate, among other things.

2. Background of the Invention

2.1 Casino Keno

The games of the present invention have to do with and relate to the general field of casino gaming (wagering/betting), and particularly to casino Keno, both live-action table play and electronic video Keno play. Keno is a popular casino game, however it has drawbacks, as noted below, all of which this present invention remedies. Keno especially lends itself to play in a wagering/betting environment because the play of the game is entirely dependent upon the deal from, in almost all cases, of and from a defined universe of numbers. In the customary game of Keno, there are eighty (80) numbers in the universe, being a pool of individual numbers, often embossed on balls, in the material world of Keno table play, or, in the alternative, depicted as individual numbers embossed on the image of the same sort of balls, on screen, in the electronic video version of the same game. The number eighty (80) is not, however, fixed, and Keno can and is played with almost any number of balls, from three to the hundreds. Still, standard casino Keno is today played with the said eighty (80) balls, and, often, express versions of the same casino Keno is played with (most often) forty (40) balls. The method put forward in the present invention, of course, finds equal application in any and all versions of Keno.

With specific regard to the deal of and from the aforesaid defined universe of numbers, it is meant that in the play of Keno, a certain amount of numbers are at random selected and drawn of and from the said universe of numbers, and, in the usual course, some twenty (20) numbers are at random drawn of and from the pool of eighty (80) numbers, leaving the balance of the unselected numbers undrawn. Again, the number of balls so drawn, and the number of balls in the overall universe of numbers to draw from, is not fixed nor controlling, and, indeed, there are several variations in these numbers, however, as already mentioned, this invention finds equal application in any and all of these Keno game varieties. Thus, it is this designation and selection of some of the numbers out of the universe of numbers that is known as the deal and draw aspect of the play of Keno, and the deal and draw of numbers is critical to the game and the integrity of the deal and draw process must be preserved as a primary element in the play of any Keno, live action or electronic.

In the casino play of Keno, live action table play or electronic video, the player pre-selects his or her preferred number or numbers, identifying from one (1) number to twenty (20) numbers, in standard play Keno, usually recording this selection on paper in table play or onscreen in electronic video Keno, and, at or about the same time, places a wager, any amount, betting that his or her pre-selected number or numbers will be matched in the forthcoming deal and draw of Keno numbers. If the player, in the ordinary course, matches some or all of his or her pre-selected numbers, he or she is designated a winner of either a large jackpot award or some other, lesser award. To win the jackpot, in the usual course of play, the player would have to match all of his or her numbers and, at the same time, have wagered on more than just a few numbers, usually more than seven (7), in order to win “big.” Alternatively, in some games, if the player pre-selects a fixed minimum number of numbers, usually ten (10) or more, and matches none of these numbers in the deal draw, he too can be designated a winner, often of a large jackpot style award. More on this subject appears below.

By way of background, it is commonly understood that the modern game of Keno finds its origin in what is known as the Chinese Lottery. The Chinese Lottery is understood by most people to have started centuries ago, and, as in Keno, a pool of numbers was used, along with player pre-selection, and a deal draw, to wager on the outcome of the number draw, and to identify both winners and losers. The game was traditionally played as a para-mutual game wherein the pool of money wagered on the game by all players was used to defray costs and expenses of play and award all the winners in the deal and draw. The Chinese Lottery, in its traditional form, is still played around the world today, often referred to in the street as “the numbers game.”

2.2 The Problem with the Play of Casino Keno Live Action Table Play or Electronic Video Keno

There are real, intrinsic drawbacks and related limitations in any and all of the aforesaid games of casino Keno. These drawbacks and the resultant limitations are common to all varieties of Keno in that all Kenos are a product of the same sort of deal and draw process. Understand that in traditional casino Keno, played with eighty (80) numbers in the number universe, and drawing twenty (20) numbers therefrom, with players pre-selecting for wager purposes from one (1) to twenty (20) numbers, there are in reality in excess of eighty billion possible outcomes. 80,000,000,000 is a very large number. Although players may not know this exact number, players are aware that winning “big” at Keno is a real long shot, meaning there is a perception among players, and an accurate one, that the chance (or odds) of winning “big” at Keno are extremely high and against the player. This is a major drawback of the game, further explained as follows:

If a player in the aforesaid standard Keno pre-selects one (1) number out of the eighty (80) in the number universe, and in the deal draw, twenty (20) numbers are identified, fully one fourth of the total numbers have been drawn (20 of the 80), hence the probability of the player matching his one (1) number to a drawn number is 4:1. These are not long odds, and, indeed, the player's chance of matching is good, however, if he or she does so match, the game of Keno cannot and does not reward the player with any sort of significant payout, and, in the usual course, the player receives 3 units or credits, not 4, for each unit or credit he or she wagered on the game. All of this is a function of the odds of the game, per the above.

If the player in the aforesaid standard Keno pre-selects just two (2) number out of the eighty (80) in the number universe, and in the deal draw, twenty (20) numbers are identified, fully one fourth of the total numbers have been drawn (20 of the 80), because numbers do funny things, so to speak, things change. Specifically, the probability of the player matching his two (2) numbers to a drawn numbers is as follows:
Match 0 of 2=0.5601265823
Match 1 of 2=0.3797468354
Match 2 of 2=0.0601265823

Hence, these become fairly long odds to hit 2 of 2, per the above, and, indeed, the player's chance of matching is less now only six percent. However, if he or she does so match, the game of Keno in the ordinary course, does not reward the player with any sort of significant payout, and, in the usual course of play, awards the player between 4 units or credits and 10 units or credits for each unit or credit he or she wagered on the game. All of this is a function of the odds of the game, per the above.

Now, if the player in the aforesaid standard Keno pre-selects ten (10) numbers out of the eighty (80) in the number universe, and in the deal draw, twenty (20) numbers are identified, fully one fourth of the total numbers have been drawn (20 Of the 80), things greatly change. Specifically, the probability of the player matching his ten (10) numbers to a drawn numbers is as follows:
Match 0 of 10=0.0457907008
Match 1 of 10=0.1796713756
Match 2 of 10=0.2952567811
Match 3 of 10=0.2674023678
Match 4 of 10=0.1473188971
Match 5 of 10=0.0514276877
Match 6 of 10=0.0114793946
Match 7 of 10=0.0016111431
Match 8 of 10=0.0001354194
Match 9 of 10=0.0000061206
Match 10 of 10=0.0000001122.

0.0000001122 is a very small number, and players understand that the chance of matching ten pre-selected numbers is, indeed, very, very small, hence, even though the standard casino Keno game advertises and will award a significant, meaning really “big” payout for this chance occurrence, the odds of this ever happening are very, very long, to say the least.

So, the upshot is that Keno is in reality a one-dimensional game, meaning it is played on just one level, no more, involving the deal and the draw, and, as a result, the odds of winning even a small payout award are fairly long, as set out in FIG. 1, and, at the same time, the odds of winning any sort of “big” jackpot payout are really, really long.

Essentially, one could conceivably play ten (10) pre-selected numbers, the same or different ones, every minute of the day, for more than a lifetime, and still not win the jackpot. Players in general recognize this circumstance. Also, see FIG. 2 and FIG. 3, for other probability and pay out data in modern day Keno.

Although the future is always difficult to predict, the popularity of casino Keno, live action or electronic video play could ebb relative to the other gaming alternatives now coming onto casino floors due to the aforesaid drawbacks and stated limitations, which are, in fact, very real.

It is the object of the related predecessor and present inventions to permit the operator of casino Keno, in live action table play or electronic video keno, to do more with the games in these formats and to, thereby, provide players with a simple, understandable, and familiar game that continues to captivate their interest while, at the same time, offering these players exciting and rewarding play, the real possibility of various bonuses, and additional large jackpots, including even mega jackpots and progressive jackpots with or without linked game play.

### SUMMARY OF THE INVENTION

The present invention extends, expands, and teaches new, and gambler-attractive, variant embodiments of the new game method for the play of any sort of live action or electronic video Keno. The related predecessor inventions and applications contemplates a new game method for the play of any sort of live action or electronic video game utilizing the deal and draw feature, whether dealing and drawing cards, per the predecessor invention, or numbers, as in the present invention. With this invention, in addition to and without any changes to the basic and well-known underlying game and play thereof, here the game being Keno, a player can win—either in a single game/stand-alone or in multiple linked and/or progressive game applications—additional awards, rewards, bonuses, prizes, large jackpots, even mega jackpots and/or progressive jackpots, all with or without any additional wager or incremental increase in wager, depending upon the overall design of the game, per below. As a consequence, the well-known drawbacks of the game, here Keno, are remedied in an obvious manner, transparent to the player, and, at the same time, the base game, and its otherwise popular features, remain unchanged. All of this is made manifest in what can be described as multi-level, simple Keno, meaning that the game, per this invention, is no longer just a one dimensional deal and draw game, and, instead, is played as a multiple level deal and draw game.

In accordance with the predecessor and related inventions and applications, all these additional awards, rewards, bonuses, prizes, large jackpots, and even mega jackpots and/or progressive jackpots—generically called “supplemental jackpots”—may be won in the same game, and above the normally applicable award schedule in Keno, with or, most commonly, without any increase in the wager, nor any placement of any additional wager. Clearly an important new element is brought to the play of Keno. By bringing more levels and aspects to the game, more win possibilities, and more awards to the game, for the same and or only somewhat more out of the player's pocket, the overall perception of the game of Keno is changed to a more positive image, being an image of a game that is fun to play, exciting, rewarding, and, in fact, actually winnable.

Moreover, the predecessor and related inventions and applications teach that this new game method is intentionally designed so that these supplemental jackpots are typically won comparatively (for the type of jackpot involved) quite frequently. This frequency immediately leads the player to believe, quite correctly, that he is playing and new and exciting kind of Keno. At the same time, it should be noted that any and all payouts, bonuses, and or supplemental jackpots are fully funded in the game, as will be explained, and, as such, the game is still a high earner of gaming revenue for the operator.

1. A Recapitulation of the Predecessor and Related Inventions

Both players and regulators in the casino betting and wagering environment are keenly aware of and do monitor all aspects of the rules, and the conduct of play, of casino games, including both the games of (1) keno and (2) electronic video poker. The programmed computerized execution of the game of poker, in particular, and particularly the manner and fashion by which the variables of the game are both established and exercised including in the randomness of the draw, are all well understood for play of the game. In accordance with the related predecessor invention all this existing structure, and existing method of play, is preserved. The probabilities of the deal and the draw are considered sacrosanct. The predecessor and related inventions in no way change the essential play, and odds, of electronic video poker. (The present and related predecessor inventions will shortly be seen to conceptually change (actually to enlarge) the database of cards from which poker hands are drawn, but in a manner that clearly obviously be immediately understood to change the fundamental odds of drawing a particular poker hand in no way whatsoever.)

In accordance with the predecessor and related inventions the electronic poker payout table normally is changed, but even this is normally only in the numbers, and the ranks, of hands for which, most commonly, and even money payout is made. Namely, a threshold is set below which pairs of a low rank will not qualify for a payout, and or some similar adjustment in the pay table is made. Notably, it is already known to so modify the payout table. Namely, casinos historically desiring to turn a higher profit on their video poker machines have for years eliminated the even money payoffs otherwise commonly made on hands containing only pairs of deuces, or even threes. Just as these casinos do not modify the probability of drawing these hands by changing (eliminating or reducing) any pay-offs therefore, so also the present related predecessor invention in no way changes the probability of drawing any poker hand.

The predecessor and related inventions do, however, draw this poker hand from a space that may usefully be considered to consist of multiple decks of cards—say fifty (50) decks—as opposed to one single—1—deck of cards. Drawing from among these fifty decks is conducted by computerized process so that the probability of drawing any one hand is exactly the same as if drawn from one single deck. Clearly the probability of initially drawing, say, the ace of spades from one deck of 52 cards is exactly the same as drawings one of the 50 aces of spades present in 50 combined decks of 52 cards each deck. Cards of identical suit and rank to any card already drawn from the 50 decks are disqualified from being subsequently drawn. For example, if the first card drawn from the combined 50 decks is one of the 50 aces of spades then none of the remaining 49 aces of spades may thereafter be drawn, leaving the draw of the second card to be among the combined (1) 50 cards of each of the aces of hearts, diamonds and clubs, and (2) the 50 cards of each suit and rank, king though deuce, that remain. It is thus impossible to draw two or more cards of identical suit and rank—just as with a draw from a single deck—and all possible poker hands are of identical probability whether considered drawn from a single deck, or from a combined 50 decks, under the procedure just described.

The reason that the predecessor and related inventions consider the draw to be from among multiple combined decks of cards—the nominal 50 decks—when the drawn poker hand is indistinguishable in the suits Spades-Hearts-Diamonds-Clubs, and in the ranks Ace through Deuce, of the cards contained is that some or all individual ones of the 2600 cards of the combined decks may be possessed of a secondary identify drawn from a group of one or more secondary identities. To explain, the primary identities of the 2600 cards, and each of them, are established by the (1) suit and the (2) rank of each such card - exactly as it always has been. This primary identity is overt, and clear, on the face of the card as shown on the monitor of a video poker machine—exactly as it always has been. More specifically, various symbols [symbol] , [symbol] , [symbol] , [symbol] in colors {back; red} in ranks A-K-Q-J-10-9-8-7-6-5-4-3-2 are displayed for each card, as is conventional.

However, in accordance with the predecessor and related inventions, certain cards of the 2600 are possessed of a secondary identity. For ease of representation, these secondary identities are called “colors”—nonetheless to possible confusion with the colors {black; red} that respectively accompany the suits ( [symbol] , [symbol] , [symbol] , [symbol] ) of the card's primary identities—these “colors” are most preferably drawn from one or more of other colors, such as Green, Purple, Blue, Orange and Yellow. Those cards having a second identity, or color, are displaced to the video poker player in a manner that is non-conflicting with, and not confusing, with the simultaneous primary identity of the card. For example, background of any card not having a secondary identity—which is normally the overwhelming majority of the 2600 cards—is normally displayed showing the background of the card as white—which is conventional. However, such individual ones of the 2600 cards as may have, by way of example, a secondary identity of “green” may conveniently be displayed with the background of the card shown as light green. Note how this display of secondary identity in no way interferes with the display, and the easy visual determination, of the primary identity of the card.

In accordance with the predecessor and related invention, pay-outs in the form of “supplemental jackpots” are made based on selected secondary identities of the composite cards of a poker hand or, more exactingly, on the second identities of the cards of the poker hand cards in combination with the ranks of these same cards. For example consider that one (only) of the 50 aces, let us say the ace of spades, within the combined 50 decks has a secondary identity of “Green”. Consider likewise that one only of the 50 Kings, one only of the 50 Queens, one only of the 50 Jacks, and one only of the 50 tens within the combined decks is also of the secondary identify color of “Green”. These cards may also be of suit “spades”, but they need not be. Now, if the probability of drawing a royal flush (A-K-Q-J-10) in spades (and in every other suit) is 1 in 2,598,960, what then is the probability of drawing a “royal flush” (still A-K-Q-J-10) that is also (and simultaneously if the cards made “Green” were all spades) in “Green”. The answer is that it is the odds that one of the required 5 useful Green cards of the 2600 cards will be first drawn, times the odds that one of the remaining 4 useful Green cards will next be drawn from the remaining 2599 cards, times the odds that one of the remaining 3 useful Green cards will next be drawn from the 2598 remaining cards, and so on. The odds of a “green royal flush) are (5/2600)×(4/2599)×(3/2598)×(2/5597)×(1/2596), or about 1 chance in 10 to the 15^{th} power (1 chance in a million billion). This is a very, very small number. Accordingly, the payout for a “royal flush in Green” may be made very high. With typical 5×$1 bet casino video poker machines paying out $4000 for a “conventional” royal flush, the supplemental jackpot for a “royal flush in Green” may easily be sent to $1,000,000, or more.

This adds a first “new dimension” to the play of casino video poker. Notably, calculation of the odds for this, and all other, hands based on the “secondary identities” of the cards is exactly analogous to the normal calculation of the odds of various poker hands. And, or course, the possibility that a poker hand should qualify for a “supplemental jackpot” in no way affects the quite independent odds that the poker had should qualify for a regular payout, and even a jackpot. (In actual practice casinos are expected to merge lesser pay-outs within larger pay-outs, and not to pay both. For example, for the “Royal Flush in Green” hand supercedes, and replaces, any payout for a normal and regular “Royal Flush”)

Notably in the related predecessor invention, any of (1) the numbers and primary identifies of cards bearing secondary identities, (2) the number of different secondary identities used, and (3) the numbers and natures of the “supplemental jackpots” paid on selected hands having cards of selected secondary identities may be greatly varied, essentially so as to mathematically control both the frequencies and the amounts of a potentially vast range of payouts of supplemental jackpots. Thus, although the probability of hitting the “Royal Flush in green” described in the preceding paragraph may be exceptionally small, it may be arranged so that other hands, and/or other secondary identities, incurring payouts (presumptively of much lesser amounts) are actually relatively frequent. There are a great number of ways to arrange these more frequent payouts, most of which are directed to making the player think that “but for” a different card he/she could have “scored” a gigantic supplemental jackpot.

As an extreme example of how this “second dimension” might work, consider that video poker machines normally have a significant payout for a straight flush. Indeed, this pay-out is, for normal hands based in primary identities, second in amount only to a royal flush, and most commonly in the amount of $250 for a wager of 5×$1 in stud poker. Now consider if, as well as the five cards making for a “royal flush in green” mentioned above, each of the deuce (2) though the nine (9) of each and all of the fifty decks was Green. There would be no straight flush ending in a nine high (or lower) that was not also, simultaneously, a “straight flush, nine high (or lower), in Green”. Straight flushes ending in nine (or lower) constitute a full 4/9 of all straight flushes that are possible, including royal straight flushes, and exactly 4/8, or 1/2, of straight flushes that are normally paid as such in video poker. Now there will also be some possible Green straight flushes—necessarily in spades—that use any of the single cards within the deck of 2600 that are any of the Green 10, J, Q, or K of spades. But this is a minuscule number. Thus it might be imagined that a “straight in Green”—almost always nine high (or lower) might also be paid $250. Yes this costs the casino money—which is recovered, as previously stated, by eliminating a number of “even money” payouts. But what is important is that, suddenly, the number of “Green supplemental jackpots” has risen dramatically. The players soon learn that “supplemental jackpots based on Green straight flushes” are not all that rare on the video poker machines (so programmed) in accordance with the related predecessor invention. The natural tendency is to believe, after hitting a $250 supplemental jackpot on a Green straight flush (of, overwhelmingly most likely, low rank) that the “royal flush in Green” cannot be long in coming.

The game play in accordance with the related predecessor invention may also be set so that payouts, normally of differing amounts and frequencies of occurrence, also transpire for selected hands in (secondary identities of) any one or ones of purple, blue, orange or yellow.

The summary effect of the completely versatile, controllable, and mathematically rigorous payout schedules of the predecessor and related inventions based on the “secondary identities” called “colors”—of each card within multiple decks of cards is to give the owner/programmer of the video poker machine an immense degree of fine control over the poker gaming experience. Normally this experience is set both so that (1) big new payouts—called supplemental jackpots—based on card secondary identities become possible, while (2) pay-outs of lesser amounts simultaneously become possible. And, all this is, of course, without effect on the underlying game, and game play, of poker. The skilled casino owner and video poker machine programmer soon learns, in accordance with the teaching of the specification of this and the related predecessor patent application, that a player can be made to feel that supplemental payouts of a certain type are not all that rare. Indeed, they are not! The player may regard this as “extra” monies received from play, and may quite naturally wish to play all the longer, and harder, so as win a monstrous “supplemental jackpot” that is seemingly of the same order and type as the player routinely does win.

2. Electronic Keno in Accordance with the Present Invention

The present invention extends the predecessor and related Inventions to the game of keno.

In one aspect of the present invention the invention is embodied in a game where the keno draw of different numbers is from a multiplicity of fields of numbers, or boards, with (1) each field, or board, having all the numbers normal to the keno game, and with (2) at least one field, or board, having associated with at least one number of the field, or board, a secondary indicia, or differentiator, each being of one or more types each of which types is called a “color”. The at least one field, or board, thus has one or more “colored numbers” each being of the one or more colors.

Numbers from any of the multiplicity of number fields, or boards, that are not associated with any secondary indicia, or differentiator, or color, are called “plain numbers”. The keno draw of different numbers can be entirely of plain numbers, but the keno draw of different numbers can also contain one or more numbers of one or more colors. No two numbers of the keno draw are the same whether plain or colored.

Further in this game the keno wagers, or tickets, containing numbers matching the keno draw sufficient for a winning payouts are paid as follows. If a winning payout of the keno ticket matches only numbers of the keno draw that are plain numbers, then the winning payout is so based on normal and conventional payouts of the keno game being played. However, if a winning payout of the keno ticket contains some predetermined quantity of numbers that match numbers of the keno draw that are colored numbers, then the winning payout is increased above levels that would correspondingly be paid should the same winning payout of the keno ticket match only numbers of the keno draw that are plain numbers.

The game of electronic keno so conducted can be considered to have at least two levels because there is one winning payout for matched numbers that are plain numbers, but another and larger winning payout for the same matched numbers should some predetermined quantity of these matched numbers also be colored numbers.

In a preferred embodiment of this keno game the number of the one or more types of differentiators, or colors, is one, and this single differentiator is arbitrarily called the color yellow”. Then, when a winning payout of the keno ticket contains so many as quantity one of numbers that match at least one drawn number that is yellow in color, the winning payout is increased. Because winning payouts on the keno ticket are increased over normal levels should matched numbers for the winning payout include even but one yellow number the keno game may be said to include one or more “jackpots” that are for winning payouts containing numbers that match drawn numbers that are yellow.

Further in the preferred embodiment, there exists at least one complete field, or board, of all the different numbers that are in use in the keno game where all the numbers of this field, or board, are differentiated by the color yellow. It is thus possible that a keno draw of different numbers will contain two or more numbers that are differentiated by the color yellow. It is further possible for a single keno ticket to contain as winning numbers a plurality of numbers that match the two or more yellow numbers of the keno draw. Thus a keno ticket with winning numbers that include even but one yellow number increases the winning payout, but a keno ticket with wining numbers that match two or more yellow numbers of the keno draw increases the payout even more.

In another of its aspects the present invention is embodied in a method of conducting a keno game. In the method the full set of different numbers for the keno game, called the keno draw, is drawn from a multiplicity of fields of numbers, or boards, of numbers with (1) each field, or board, having all the numbers normal to the keno game, and with (2) at least one field, or board, having associated with at least one number of the field, or board, a secondary indicia, or differentiator, each being of one or more types each of which types is called a “color”, this at least one field, or board, thus having one or more “colored numbers” each being of the one or more colors. The numbers from any of the multiplicity of number fields, or boards, that are not associated with any secondary indicia, or differentiator, or color, are called “plain numbers”. No two numbers of the keno draw are the same whether plain or colored, but the keno draw of different numbers can also contain one or more numbers each of one or more colors.

Keno wagers, or tickets, containing numbers matching the keno draw sufficient for a winning payout are paid as follows: if a winning payout of the keno ticket matches only numbers of the keno draw that are plain numbers, then the winning payout is so based on normal and conventional payouts of the keno game being played; but if a winning payout of the keno ticket contains some predetermined quantity of numbers that match numbers of the keno draw that are colored numbers, then the winning payout is increased above levels that would correspondingly have been paid should the same winning payout of the keno ticket matched only numbers of the keno draw that are plain numbers.

The game of keno so conducted can be considered to have at least two levels because there is one winning payout for matched numbers that are plain numbers, but another and larger winning payout for the same matched numbers should some predetermined quantity of these matched numbers also be colored numbers.

In yet another of its aspects, the present invention may be considered to be embodiment in an electronic keno game having a conceptual database of possible numbers from which a full set of different numbers for the keno game, called the keno draw, may be drawn. This conceptual database has a multiplicity of conceptual fields of numbers, or boards, with (1) each number field, or board, having all the numbers normal to the keno game, and with (2) at least one number field, or board, having associated with at least one number of the field, or board, a secondary indicia, or differentiator, each being of one or more types each of which types is called a “color”. This at least one conceptual number field, or board, thus has one or more “colored numbers” each being of the one or more colors.

An electronic computer is used to draw a full set of different numbers for the keno game, called the keno draw, from the conceptual database. Those drawn numbers from any of the multiplicity of conceptual number fields, or boards, that are not associated with any secondary indicia, or differentiator, or color, are called “plain numbers”. No two numbers of the keno draw are the same whether plain or colored, but the keno draw of different numbers can also contain one or more numbers that are each of one or more colors.

Finally, the same, or a companion, computer pays the keno wagers, or tickets, containing numbers matching the keno draw sufficient for a winning payouts as follows: if a winning payout of the keno ticket matches only numbers of the keno draw that are plain numbers, then the winning payout is so based on normal and conventional payouts of the keno game being played; but if a winning payout of the keno ticket contains some predetermined quantity of numbers that match numbers of the keno draw that are colored numbers, then the winning payout is increased above levels that would correspondingly have been paid should the same winning payout of the keno ticket matched only numbers of the keno draw that are plain numbers.

The electronic keno game can therefore be considered to have at least two levels because there is one winning payout for winning numbers matching the keno draw that are plain numbers, but there is another and larger winning payout for the same winning numbers should some predetermined quantity of these winning numbers also be colored numbers that are within the keno draw.

### BRIEF DESCRIPTION OF THE DRAWINGS

FIG. 1, consisting of FIGS. 1A and 1B and 1C, shows Keno Game Probabilities, setting out in column form the probabilities involved in modern day play of Keno, utilizing overall eighty (80) numbers in the field and drawing there from, at random, twenty (20) such numbers in the play of the game.

FIG. 2, consisting of FIGS. 2A and 2B and 2C, shows Keno Game Probabilities, setting out in column form the probabilities involved in modern day play of Keno, utilizing overall forty (40) numbers in the field and drawing there from, at random, ten (10) such numbers in the play of the game.

FIG. 3, consisting of FIGS. 3A and 3B and 3C and 3D, sets out the probabilities and relevant pay outs for modern day play of Keno, utilizing overall eighty (80) numbers in the field and drawing there from, at random, twenty (20) such numbers in the play of the game; included in this FIG. 3 is data concerning everything from two (2) spot or number Keno to ten (10) spot or number Keno.

### DESCRIPTION OF THE PREFERRED EMBODIMENT

As previously stated, the present invention extends the predecessor and related inventions to the game of keno.

Also as stated in previous sections, both players and regulators in the casino betting and wagering environment are keenly aware of and do monitor all aspects of the rules, and the conduct of play, of live action as well as electronic video Keno. In electronic video Keno, the programmed computerized execution of the game, and particularly the manner and fashion by which the variables of the game are both established and exercised including in the randomness of the deal and draw, are all well understood for play of the game. In accordance with the related predecessor invention all this existing structure, and existing method of play, is preserved. The probabilities of the deal and the draw are considered sacrosanct. The predecessor and related inventions, and the present invention, in no way change the essential play, and odds, of live action or electronic video Keno. The predecessor and related inventions, and the present invention, will shortly be seen to conceptually change (actually to enlarge) the database from which the draw is made, but in a manner that clearly and obviously in no way whatsoever changes the fundamental odds of drawing any particular outcome.

In the present invention, in order to enhance the game play of live action as well as electronic video Keno, the deal and draw process is sacrosanct. Players must know and understand this as true for the integrity of the game and for play of the game, per the present invention, to be played as Keno.

Now, in the ordinary course of the play of Keno, live action or electronic video Keno, the deal and draw involve a single universe of numbers, and the number of numbers therein, usually eighty (80) is not controlling. It is from this pool of numbers, for example, number one (1) to number eighty (80), all being different numbers that the draw is made. In that all the numbers in the pool are different, no two drawn numbers are the same, and this circumstance is a hallmark of the play of the game of Keno. Hence, in the present invention, the deal and draw features are respected, and, in the play of the game of Keno, per this invention, no two numbers drawn from the deal are the same.

With the above said, the following can be added, and the play of the game of Keno remains the same at its core, however it in reality becomes a multi-dimensional game, offering more features and excitement, and rewards than the standard game. Instead of just a single eighty (80) number universe of different numbers to deal and draw from, in the present invention, more than one such eighty (80) number universe of different numbers is employed, in material form, in live action play, or in the electronic database, in electronic video Keno. The number of eighty (80) number universes in the overall pool is not fixed, and, instead, is almost infinite, and, for example, in one configuration of this present invention, there could be ten (10), and, so long as the same number is not allowed to be drawn twice, the overall play of the game remains the same as if only one such eighty (80) number universe is in play. In the present invention, however, in order to add new levels of play to the game of Keno, per the above, consistent with the method of this new invention, at least part or all of at least one, perhaps more, of the eighty (80) number universes making up the overall pool of numbers can be distinguished with some sort of special indicia, here, for example purposes, a color, being the color Yellow.

So, in this example, there is presented, then, for purposes of the standard deal and draw of Keno, a pool of numbers made up of ten (10) eighty (80) number universes, being the numbers 1 through 80, wherein at least part or all of at least one eighty (80) number universe is distinguished, here, with the color Yellow whereas the other nine (9) eighty (80) number universes have no such color or designation and are, thus, clear or white.

It may be understood that the type and number of numbers in the number universe, and the number of universes in the overall pool, are not fixed and, indeed, are variable almost to infinity, and, in any case, the present invention finds equal application in all such variations.

The result of the above, following the basic rule that no two drawn numbers are the same, is clear: the game of Keno now is imbued with more than one dimension. In actual play of this Keno, the same player referenced above pre-selects his or her numbers, say ten (10) such numbers, and places a wager. The deal and the draw proceeds as usual, and fully twenty (20) numbers are identified. On one level, if the player matches his or her numbers to those drawn he or she is, of course, a designed winner. In addition, consistent with the method employed by this invention, if one, more than one, or all of the matching numbers so drawn were drawn from the Yellow universe, being Yellow numbers, then, the player can win other, more, and or different prizes, bonuses, awards, even jackpots, all depending upon the design of the game per se.

Here, an examination of the simplest form of Keno play is in order, to further highlight the power of the present invention: to wit the player who marks only one (1) number in an effort to match that drawn in the deal and draw. If this player by chance achieves this objective and matches a clear, or white, number in the draw, he is designated a winner, in live action or electronic format. If he fails to so match, he loses. If he is a designated winner, per what has been set out above, he cannot win any sort of large award or jackpot in ordinary Keno, and, in the usual course, is paid no more than 3 credits for any I credit he or she wagered.

Now, as a result of the method employed by the present invention, thereby making the play of standard Keno multi-level rather than single-level, more is in play. To wit, if the player not only matches his single number but also matches it to a Yellow number drawn in the deal and draw, instead of winning just 3 small credits then he or she can be awarded much more, for example, 30 credits, even though the player is playing Keno at a level wherein no such large payout has ever before been possible.

Taking this example further, a look at the player, per the above, pre-selecting just two numbers further shows the power of the present invention. If this player by chance achieves this objective and matches two clear, or white, numbers in the draw, he is designated a winner, in live action or electronic format. If he fails to so match, he loses. If he is a designated winner, per what has been set out above, he cannot win any sort of large award or jackpot in ordinary Keno, and, in the usual course, is paid between 4 and 10 credits for any 1 credit he or she wagered.

Now, as a result of the method employed by the present invention, thereby making the play of standard Keno multi-level rather than single-level, more is truly in play, even at this low end of the Keno spectrum. To wit, if the player not only matches his two numbers but also matches them to two Yellow numbers drawn in the deal and draw, instead of winning just 4-10 small credits he or she can be awarded much more, for example, 100 or more credits, even though the player is playing Keno at a level wherein no such large payout has ever before been possible.

If per the above, a player does in fact pre-select more than one number for play in Keno subject to the present invention, multiple play and payout opportunities are thereby created. For example, in the above example wherein the player marked just two numbers for play, in addition to what is said in the above, consider this: if one but not both of the player's winning numbers is drawn out Yellow in the deal draw, then he or she, in addition to the customary 4 to 10 credit payout can be awarded an additional payout, of say, 25 more credits, just for matching one of his or her numbers to the more rare Yellow deal draw number. This, in a sense, is a bonus, and, as such, adds another level of play and pay to the game as well as tremendous anticipation and excitement. This same format can be used throughout the deal and draw process, for any and all of the numbers pre-selected for play by players.

It should be noted that although the above example employs only a single distinguishing indicia, here the color Yellow, more than one such indicia, or color, almost to infinity, can be employed pursuant to the method presented by this invention, hence all or part of one or more number universes (being eighty numbers, more or less), can be so distinguished with some sort of special indica, or color, so there could, thus, be in play, Yellow numbers, Orange numbers, Blue numbers, Purple numbers, Green numbers, and so on, and on, and on. . . .

All of the above, per the present invention, remedies the various noted drawbacks of customary casino life action or electronic video Keno, and, at the same time, brings new life, new anticipation, new excitement, and new reward to the play of simple Keno. In particular, a player may desirably become more involved in assessing his betting card for both numbers, and number colors.

In this same regard, one more point should here be made before proceeding. In all of the above instances, the method of the present invention has demonstrated how to make either small or large winners into bigger winners. Still, a recognized feature of a great variation in play is the ability to make losers into winners. This, from a game design standpoint, is all-important, and any game with this ability has strong competitive advantages over other like games. The method employed in the present invention has the inherent ability to do this, meaning to make losers into winners, depending upon the objectives of the specific game and the design, and, in this regard, there are an infinite number of variations all of which are subject to the method employed in the present invention. Here is one example:

In the above, the player that pre-selected ten (10) numbers to match to those of the deal and draw is a loser if and when he matches only three (3) such numbers. Now, as a result of the method employed in the present invention, depending upon the objectives of the overall game design, this losing player can indeed be made into a winner. Here is how: If one, two, or three of the three numbers so pre-selected by the player match three in the deal and draw, and, if one, two, or three of the numbers so drawn have a special indica, or color, here the color Yellow, then, the player has matched some of his numbers to the more rare appearing Yellow numbers, hence he can be designated a winner. Say the player matches three numbers in the deal and draw, and all three matches are with Yellow numbers. In this case the player could be designed not only a winner but a “big” winner and, instead of receiving a payout of zero, he or she could be paid upwards of 500 credits for each one wagered, more or less.

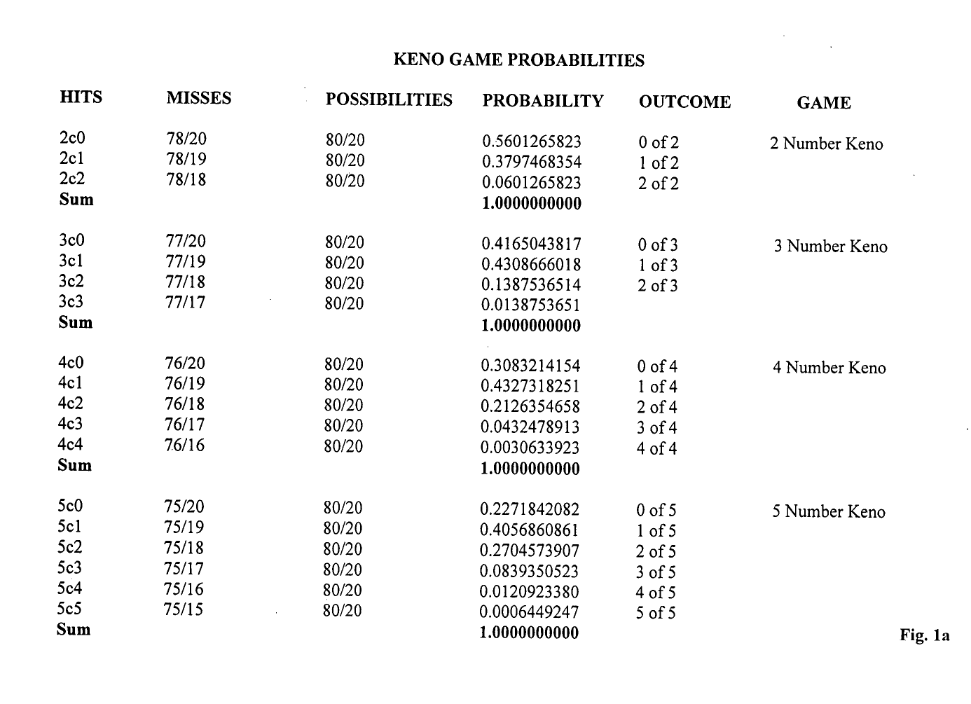

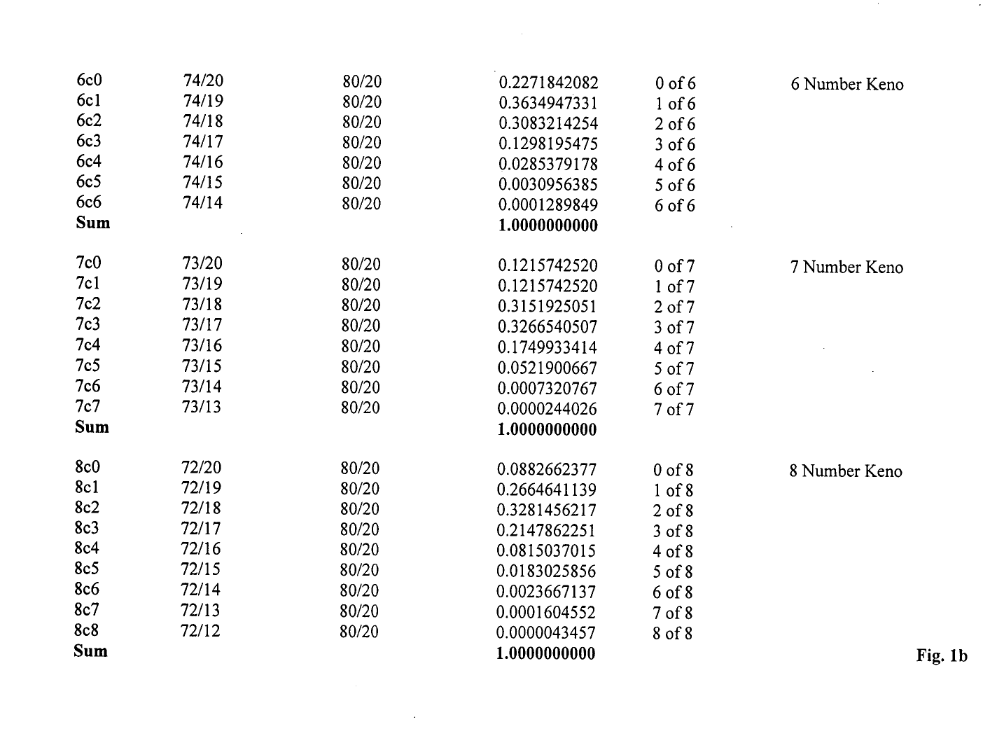

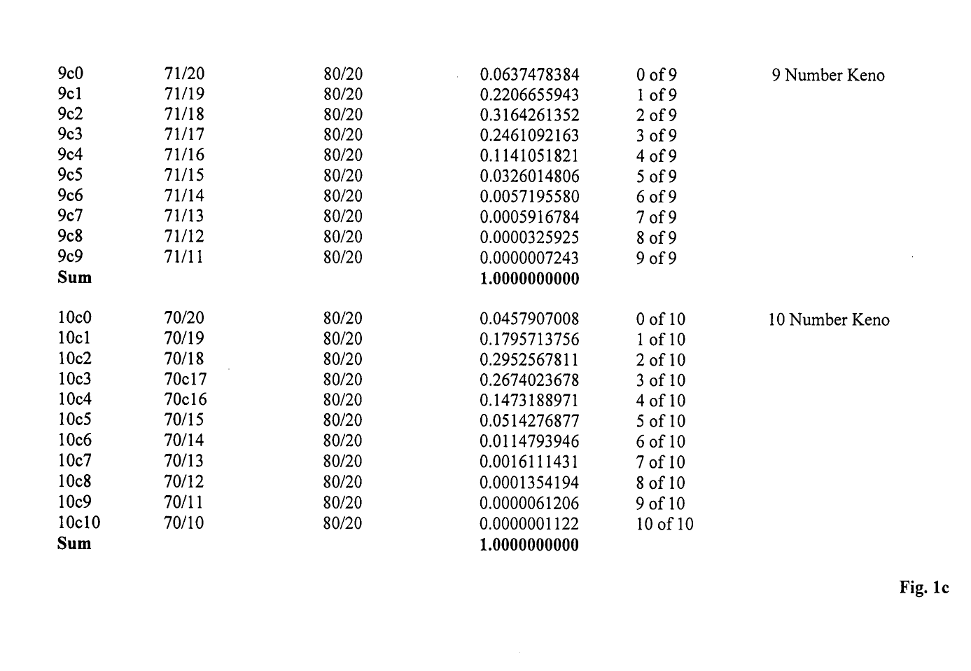

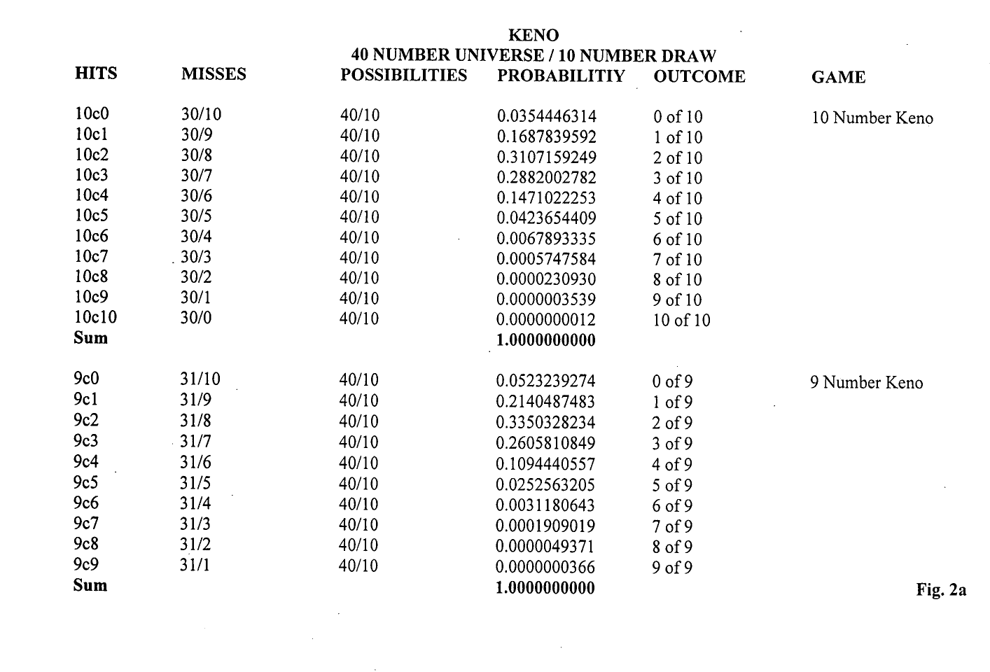

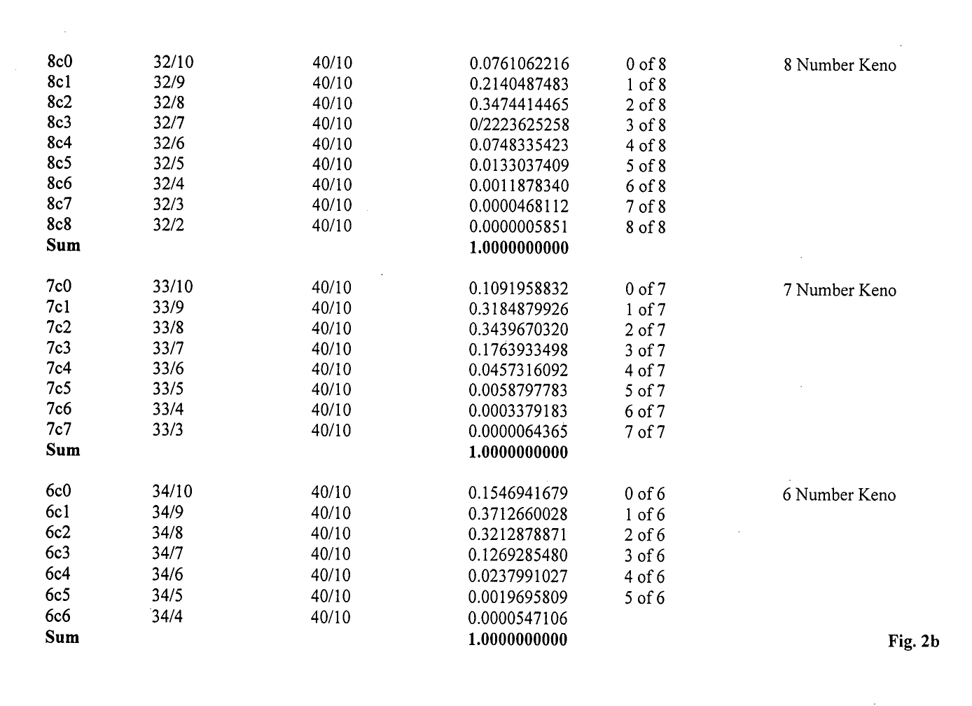

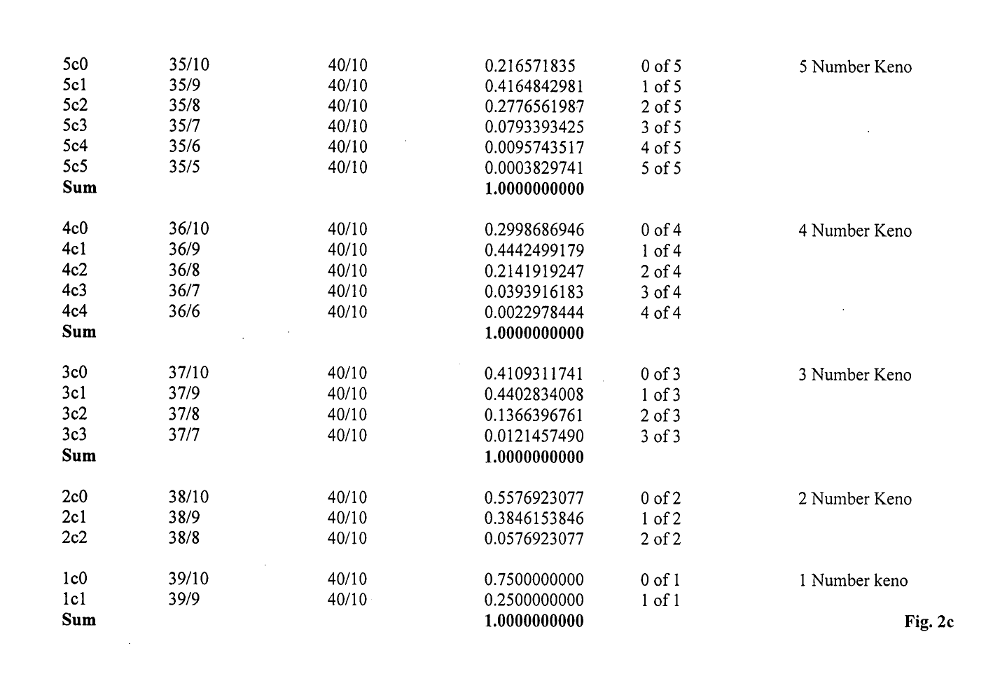

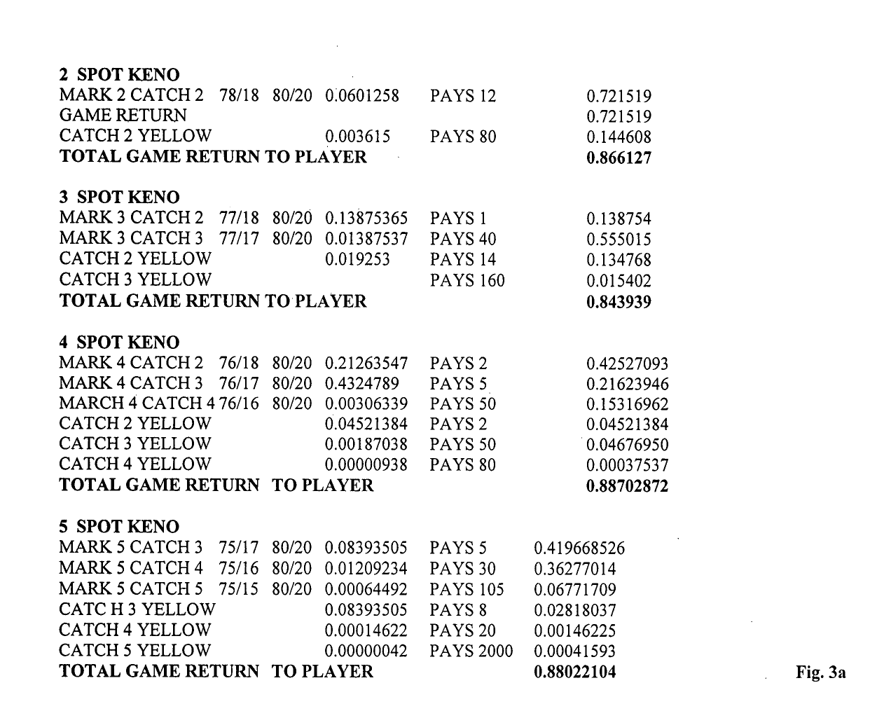

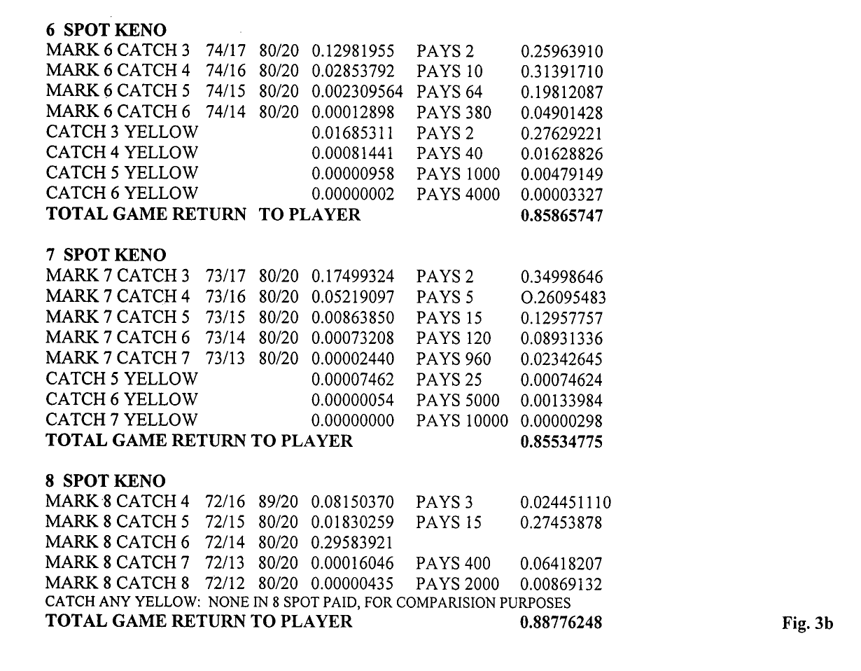

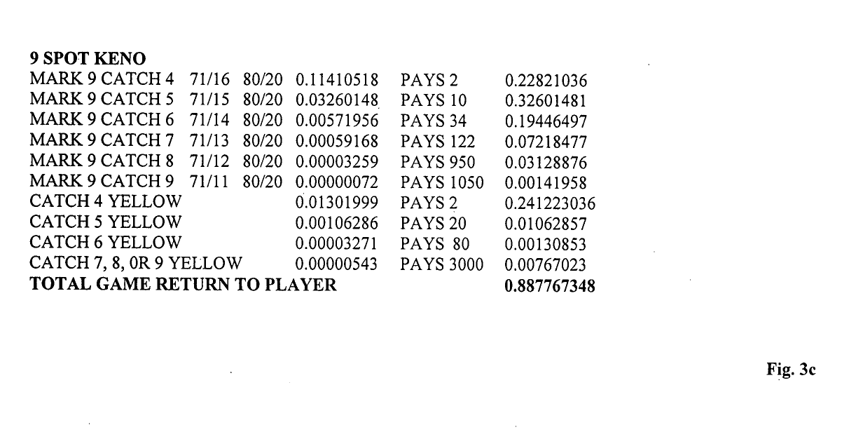

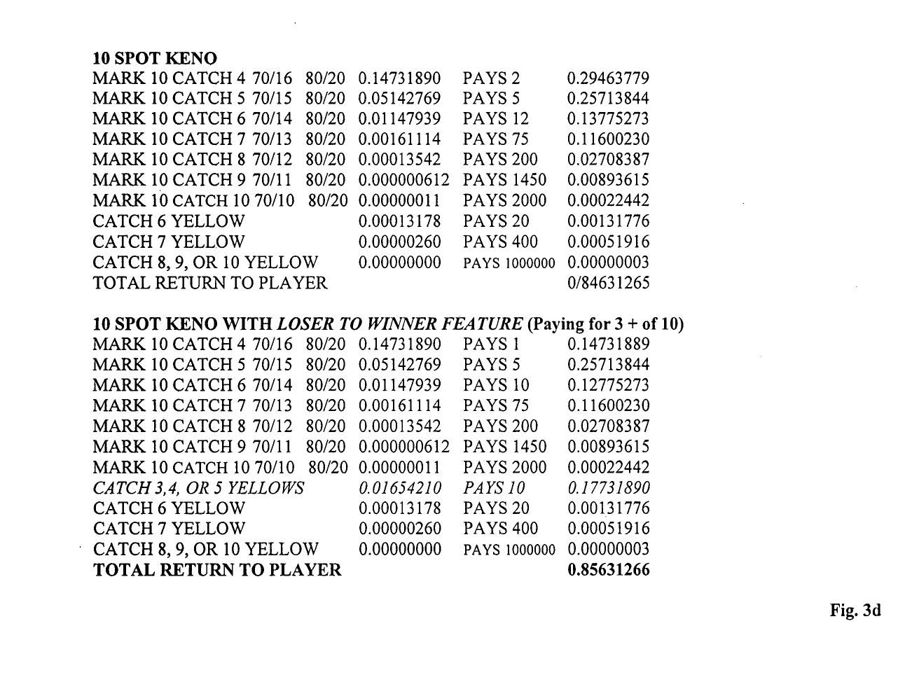

The above is but one example of the possibilities made possible by this invention and the resultant multi-level keno experience envisioned by this invention. FIG. 1 set out the Hits/Misses/Possibilities and Probabilities for standard eighty (80) number Keno, drawing twenty (20), allowing for pre-selection of from two (2) to ten (10) numbers. FIG. 2 sets out the Hits/Misses/Possibilities and Probabilities for standard forty (40) number Keno, drawing ten(10), allowing for pre-selection of from one (1) to ten (10) numbers.

2. Dictionary

In the present specification, the terms of keno are defined as follows:

Aggregate Limit—The accumulated ceiling on payoffs by the casino for any individual keno game. Will differ according to the casino.

All or Nothing—A keno ticket that can pay you in two ways, and two ways only—if all the numbers you pick get drawn, or if none of the numbers you pick get drawn.

Ball Game—Type of keno game where the numbers drawn are represented by plastic balls blown through a plastic tube.

Balls—This refers to the balls, numbered 1-80, that are used to determine the numbers drawn in a keno game.

Bank—The money used by the house to back its action in keno.

Bankroll—The amount of money the player has available for wagering.

Bet—The amount of money wagered by the player in an individual game or on an individual ticket.

Bingo—A game where numbers are drawn at random from a field of 75. Players have cards with 25 numbers on them in a 5×5 grid, and must be the first to complete a vertical, horizontal or diagonal row on their card with drawn numbers in order to be declared a winner.

Blank—A keno ticket that has yet to be played.

Blower—Plexiglas “bubble” from which keno balls are blown through a tube and drawn for the game.

Bowl—Before the “blower” goes to work, this is where all the keno balls are stationed on the machine.

Buy-In Tournament—A contest where players pay a designated fee to compete, which is actually in the form of usable bankroll, with monetary losses sustained and winning kept.

This contest is played under an express set of rules, which will usually mandate that a specific number of keno tickets are played.

Cage—A wire cage used to roll the keno balls around, after which they will be picked out. Also referred to as a “bird cage” or a “tumbler.”

Call—The process of announcing the keno balls as they are drawn.

Caller—When numbers are drawn for the keno game, they are “called.” This is the employee who does that.

Catch—A number marked by the player that is subsequently selected during the draw.

Catch-All—A game where all the numbers you select on your keno ticket must be drawn in order for you to win.

Catch-Zero—A game where none of the numbers you select on your keno ticket must be drawn in order for you to win.

Close—The moment the casino stops writing keno tickets. Right before the draw, for example, wagering “closes” out.

Combination Ticket—A ticket that can have a number of different keno wagers on it, thus creating more ways to win.

Computer Ticket—The official ticket you get back from the keno writer confirming those selections you manually make on the one you handed in.

Conditioning—Usually when there are ways or options available for the player on the combination tickets, these are the rules or terms under which the bets and determination of winners will be governed.

Crayon—Customarily black, it's the instrument used to mark numbers on a player's keno ticket.

Deuce—Two numbers, or “spots” grouped together by the player as marked on the keno ticket.

Draw—The full set of numbers selected for each keno game. Consists of 20.

Draw Sheet—The printed record of numbers drawn for a previously played keno game. Perforated holes are made in the sheet, corresponding to selected numbers.

Edge Ticket—Where the numbers marked are those that completely make up the outside edge of the ticket.

Enhanced Payoff—The payoff that results from playing combinations contained within one keno ticket as opposed to putting each one on a separate ticket.

Entry Fee Tournament—Contest where players put up a straight fee to compete against each other for prizes. Unlike the buy-in tournament, there are no cash wins or losses on the individual game within the tournament.

Exacta—A keno ticket which is good for two games, offering a special payout.

Expected Value—The rate of occurrence of a certain outcome in a keno game.

Field—The numbers that a player marks on a keno ticket but does not circle. Also refers to the entire board of 80 numbers in a keno game.

Flashboard—See “keno board.” Also known as the “Big Board.”

Fractional Rate Ticket—A ticket offering a discounted minimum. Generally offered on a way ticket, where the price per “way” is less than the usual minimum.

Free Play—A keno ticket that wins without a payoff, other than to allow you to play “free” the next time.

Goose—The apparatus that takes one keno ball at a time and sends it into the tube to be drawn.

Group—A collection of spots that are circled on a ticket.

Handle—The amount of money the casino “handles”; i.e., the amount it pulls in from keno over some specific period.

High End Ticket—A keno ticket that pays off more handsomely for a large number of matching spots, with much less reward for matching a low number of spots.

High Roller Ticket—Generally, the tickets that carry the highest minimum bets.

Hit—A number marked on a ticket matching that of a drawn number.

Hold—That portion of the handle the casino keeps after paying off all winners.

House—The casino which the player is essentially competing against in the game of keno.

House Edge—This is the percentage advantage the house has over the player in keno. Thought to be around 30%.

House Percentage—See “House Edge.”

Inside Ticket—A ticket after it is marked by the player and turned into the keno window.

Jackpot—The amount of “bonus” money, so to speak, that is paid off as the top prize in a progressive is won. Calculated as progressive payoff minus customary payoff.

Jackpot Meter—A sign—usually electronic—which indicates a jackpot that is current at that time.

Keno—A lottery-type game, with origins in ancient China. In the modern version, the house draws 20 numbers from a field of 80, and players mark tickets with selected numbers in an attempt to match as many numbers as possible to those “winning numbers” the house draws.

Keno Board—Also known as the “Big Board,” it is the display that shows the numbers drawn for each game of keno. Located around the casino, the keno lounge, bars, restaurants and other areas where players may be participating.

Keno Balls—See “Balls.”

Keno Computer—The apparatus used by the casino to run the keno game and perform many of the functions associated with it, including writing tickets, designating winners, generating payouts, keeping records of past games, and more.

Keno Counter—Also known as the keno “window.” This is where the keno transaction actually takes place; where the player or keno runner brings the wager and the marked ticket and receives the computerized ticket.

Keno Crayon—See “Crayon.”

Keno Lounge—Centralized area where participants can sit, relax and watch the games. The keno counter is nearby, the Dashboards are in plain view, and there are all necessary materials readily available, including brochures, crayons, blank keno tickets, etc.

Keno Manager—The person who is responsible for overseeing a casino's keno activities. Would fall into the category of middle management within the casino infrastructure.

Keno Punch—Apparatus that punches holes in a draw sheet that correspond to the numbers that were drawn for a keno game.

Keno Writer—In effect, the “clerk” who accepts the wagers, pays off the winners, prints the tickets, and interacts with the customers and the keno runners.

King—One single number that is circled on a keno ticket. Used by some people in conjunction with various “way” bets.

King Ticket—A ticket that contains at least one king, each circled so as to identify it as a “group of one.”

Left-Right Ticket—A ticket where the player bets on whether numbers drawn will be on the left side or right side of the ticket.

Limit—See “Aggregate Limit.”

Live Keno—Keno played in a so-called “paper” setting, using tickets and crayons, as opposed to video keno or internet keno. In live keno, there is nothing pre-programmed; the numbers are drawn “live.”

Lounge—See “Keno Lounge.”

Mark—The designation of a number the participant/bettor intends to play on a keno ticket.

Multi Game Keno Ticket—A ticket which can be used for a number of keno games, sometimes up to thousand.

Net Win—The player's payoff, minus the amount wagered. For example, if $18 was won, on $1 wagered, there would be a $17 net win.

Odds—The chances an event will occur, expressed quantitatively as a ratio. For example, if there is a one in four chance something will happen, the odds on that event are 3-to-1.

Open—The period during which wagers on keno can be taken—before and after which it is “closed.”

Outside Ticket—The computer-generated ticket that is the result of the player marking his ticket and executing a transaction at the keno counter. This is the only ticket that is official for the purposes of paying off winners.

Pattern—Groups of selected numbers selected on a keno ticket that take on a distinctive and intended formation. For example, the “bottom row” pattern, a box pattern, or a “sideways cross.”

Pay Any Catch Ticket—A ticket that pays off, regardless of the numbers of “catches” the player has.

Paybook—A brochure explaining many of the aspects of the keno game, including the payouts, rules, ticket prices, types of wagers, instructions on how to play, etc.

Payoff—The amount of money a player gets paid when he wins.

Pay Table—A schedule detailing the payoffs for each individual winning scenario.

PC—See “House Edge.”

Percentage—See “House Edge.”

Prize—See “Payoff.”

Probability—Essentially the same as the odds, except it can be expressed as a percentage. For example, something that has a one in four chance of occurring has a 25% chance of happening.

Progressive—A game where the top prize is not automatically won at the conclusion of each game, but instead continues to increase in value until that ultimate prize is won. The criteria for winning, along with the intervals at which the progressive will increase, are determined by the casino.

Punch Outs—See “Draw Sheet.”

Push—A tie, in effect. The win comes out to the same amount as the money bet.

Quick Pick—A ticket where the player chooses the option of having the casino's computer generate the selection of numbers, as opposed to the player himself making those selections manually.

Quit Race—The act of a player taking his or her ticket and cashing it out before all of the games covered by the ticket have been completed.

Race—Another name for a game of keno. The game was named Race Horse Keno, in which each number was designated as a “horse.” This was in order to get around laws in Nevada that did not allow lotteries.

Rack—Where the keno balls reside until they are drawn for each game.

Random Number Generator—A program designed to select numbers at random for a keno game.

Rate—The price the casino establishes per ticket played, and also for each “way” on a combination ticket.

Rate Card—Indicates the “rate” at which each winning bet pays.

Regular Ticket—The standard keno ticket.

Replayed Ticket—A ticket which contains the same numbers the player had marked for a previous game, which is handed in to the keno counter for the purposes of “replaying.”

RNG Game—A keno game which uses a random number generator to draw the numbers.

Runner—An employee that picks up wagers and pays winnings to people who are sitting in areas of the casino other than the keno lounge. They exist for the convenience of players who are in bars or restaurants, or who are playing other games in the casino.

Shift Boss—The casino employee who oversees keno operations on a shift-by-shift basis. Generally responsible to the keno manager.

Sleeper—A ticket that yields a win but has not been cashed in yet.

Special Rate—A rate that varies from the regular rate established at the casino for a ticket.

Split Ticket—A ticket that gives the player the option of playing more than one game on an individual ticket. The games are signified by the designation of groups of numbers on that ticket. The split ticket generally does not allow the same numbers to appear in two different groups.

Spot—A number that is marked by the player on a ticket.

Straight Ticket—See “Regular Ticket.”

Ticket—The piece of paper the player uses to select numbers and combinations for a game of keno. It is turned into the keno counter, along with a wager, to constitute an official transaction.

Top-Bottom Ticket—Type of ticket where the player bets on the top 40 numbers or bottom 40, and gets paid depending on how many of them hit.

Tournament—A keno “contest” where players compete against each other, in addition to the house, with prizes offered for the best finishers.

Video Keno—Keno which is played on an electronic machine, and which moves faster than live keno. A random number generator is used for this type of game. Online keno may also be considered a form of video keno.

Wager—The amount the player decides to put at risk in a keno game.

Way—Another method of betting on a keno ticket, usually the product of grouping two or more numbers or spots on a combination ticket.

Way Ticket—A ticket which allows for many different wagers—groups or combinations of numbers—theoretically producing a number of “ways” to win

Win—Hitting enough numbers to yield a payoff offering the player a net profit.

Winning Numbers—The full draw of twenty numbers. If these numbers are matched on a player's ticket, it can constitute a win.

Wire Cage—See “Cage.” also known as “Bird Cage.”

Writer—See “Keno Writer.”

Other terms are given their standard and common, dictionary, definitions.

In accordance with the preceding explanation, variations and adaptations of multi-level simple Keno in accordance with the present invention will suggest themselves to a practitioner of the game design arts. For example, as should already be clear, the “secondary identify” of selected numbers need not literally be “colors”, but this indicia may be realized by other means ranging from special graphic depictions of the numbers bearing a second identify, permissively in accompaniment with symbols or icons, to the rendering of these numbers in holographic image.

In accordance with these and other possible variations and adaptations of the present invention, the scope of the invention should be determined in accordance with the following claims, only, and not solely in accordance with that embodiment within which the invention has been taught.

What is claimed is:

1. A keno game CHARACTERIZED IN THAT
a draw of different numbers are drawn from a multiplicity of fields of numbers, or boards, with (1) each field, or board, having all the numbers normal to the keno game, and with (2) at least one field, or board, having associated with at least one number of the field, or board, a secondary indicia, or differentiator, each being of one or more types each of which types is called a “color”, the at least one field, or board, thus having one or more “colored numbers” each being of the one or more colors,
wherein numbers from any of the multiplicity of number fields, or boards, that are not associated with any secondary indicia, or differentiator, or color, are called “plain numbers”,
wherein the keno draw of different numbers can be entirely of plain numbers, but
wherein the keno draw of different numbers can also contain one or more numbers of one or more colors,
wherein no two numbers of the keno draw are the same whether plain or colored; and
keno wagers, or tickets, containing numbers matching the keno draw sufficient for a winning payouts are paid as follows
if a winning payout of the keno ticket matches only numbers of the keno draw that are plain numbers, then the winning payout is so based on normal and conventional payouts of the keno game being played;
but if a winning payout of the keno ticket contains some predetermined quantity of numbers that match numbers of the keno draw that are colored numbers, then the winning payout is increased above levels that would correspondingly be paid should the same winning payout of the keno ticket match only numbers of the keno draw that are plain numbers;
wherein the game of keno can be considered to have at least two levels because there is one winning payout for matched numbers that are plain numbers, but another and larger winning payout for the same matched numbers should some predetermined quantity of these matched numbers also be colored numbers.

2. The keno game according to claim 1 FURTHER CHARACTERIZED IN THAT
the number of the one or more types of differentiators, or colors, is one, and this single differentiator is arbitrarily called the “color yellow”;
wherein if a winning payout of the keno ticket contains so many as quantity one of numbers that match at least one drawn number that is yellow in color, then the wining payout is increased;
wherein because winning payouts on the keno ticket are increased over normal levels should matched numbers for the winning payout include even but one yellow number the keno game may be said to include one or more “jackpots” that are for winning payouts containing numbers that match drawn numbers that are yellow.

3. The keno game according to claim 2 FURTHER CHARACTERIZED IN THAT
there exists at least one complete field, or board, of all the different numbers that are in use in the keno game where all the numbers of this field, or board, are differentiated by the color yellow;
wherein it is possible that a keno draw of different numbers will contain two or more numbers that are differentiated by the color yellow;
wherein it is possible for a single keno ticket to contain as winning numbers a plurality of numbers that match the two or more yellow numbers of the keno draw;
wherein a keno ticket with winning numbers that include even but one yellow number increases the winning payout, but a keno ticket with wining numbers that match two or more yellow numbers of the keno draw increases the payout even more.

4. A method of conducting a keno game comprising:
drawing the full set of different numbers for the keno game, called the keno draw, from a multiplicity of fields of numbers, or-boards, of numbers with (1) each field, or board, having all the numbers normal to the keno game, and with (2) at least one field, or board, having associated with at least one number of the field, or board, a secondary indicia, or differentiator, each being of one or more types each of which types is called a “color”, this at least one field, or board, thus having one or more “colored numbers” each being of the one or more colors,
wherein numbers from any of the multiplicity of number fields, or boards, that are not associated with any secondary indicia, or differentiator, or color, are called “plain numbers”,
wherein no two numbers of the keno draw are the same whether plain or colored; but
wherein the keno draw of different numbers can also contain one or more numbers each of one or more colors; and
paying keno wagers, or tickets, containing numbers matching the keno draw sufficient for a winning payout as follows
if a winning payout of the keno ticket matches only numbers of the keno draw that are plain numbers, then the winning payout is so based on normal and conventional payouts of the keno game being played;
but if a winning payout of the keno ticket contains some predetermined quantity of numbers that match numbers of the keno draw that are colored numbers, then the winning payout is increased above levels that would correspondingly have been paid should the same winning payout of the keno ticket matched only numbers of the keno draw that are plain numbers;
wherein the game of keno so conducted can be considered to have at least two levels because there is one winning payout for matched numbers that are plain numbers, but another and larger winning payout for the same matched numbers should some predetermined quantity of these matched numbers also be colored numbers.

5. An electronic keno game comprising:
a conceptual database of possible numbers from which a full set of different numbers for the keno game, called the keno draw, may be drawn, this conceptual database having a multiplicity of conceptual fields of numbers, or boards, with (1) each number field, or board, having all the numbers normal to the keno game, and with (2) at least one number field, or board, having associated with at least one number of the field, or board, a secondary indicia, or differentiator, each being of one or more types each of which types is called a “color”, this at least one conceptual number field, or board, thus having one or more “colored numbers” each being of the one or more colors;
an electronic computer for drawing the a full set of different numbers for the keno game, called the keno draw, from the conceptual database, the numbers from any of the multiplicity of conceptual number fields, or boards, that are not associated with any secondary indicia, or differentiator, or color, being called “plain numbers”, where no two numbers of the keno draw are the same whether plain or colored, but where the keno draw of different numbers can also contain one or more numbers that are each of one or more colors; and
a computer paying keno wagers, or tickets, containing numbers matching the keno draw sufficient for a winning payouts as follows
if a winning payout of the keno ticket matches only numbers of the keno draw that are plain numbers, then the winning payout is so based on normal and conventional payouts of the keno game being played;
but if a winning payout of the keno ticket contains some predetermined quantity of numbers that match numbers of the keno draw that are colored numbers, then the winning payout is increased above levels that would correspondingly have been paid should the same winning payout of the keno ticket matched only numbers of the keno draw that are plain numbers;
wherein the electronic keno game can be considered to have at least two levels because there is one winning payout for winning numbers matching the keno draw that are plain numbers, but there is another and larger winning payout for the same winning numbers should some predetermined quantity of these winning numbers also be colored numbers that are within the keno draw.
